(19) United States
(12) Patent Application Publication
(10) Pub. No.: US 2025/0142518 A1
(43) Pub. Date: May 1, 2025

(54) METHODS AND APPARATUS FOR MEASURING POSITIONING REFERENCE SIGNAL IN A WIRELESS COMMUNICATION SYSTEM

(71) Applicant: Samsung Electronics Co., Ltd., Suwon-si, Gyeonggi-do (KR)

(72) Inventors: Pengru LI, Beijing (CN); Qi XIONG, Beijing (CN); Feifei SUN, Beijing (CN)

(21) Appl. No.: 18/837,027

(22) PCT Filed: Feb. 16, 2023
(86) PCT No.: PCT/KR2023/002271

§ 371 Date: Aug. 8, 2024

(30) Foreign Application Priority Data
Feb. 18, 2022 (CN) 202210152359.5

(51) Int. Cl. H04W 64/00; G01S 5/00; G01S 5/02; G01S 5/10

(52) U.S. Cl. CPC H04W 64/00; G01S 5/0036; G01S 5/0236; G01S 5/0273; G01S 5/10

(57) ABSTRACT

The disclosure relates to a 5G or 6G communication system for supporting a higher data transmission rate. Specifically, the disclosure related to method and apparatus for measuring positioning reference signal in a wireless communication system. The method and apparatus for performing a receiver and a method and apparatus for performing a transmitter in a wireless communication system, as well as a transmitter device and a receiver device are provided herein. Wherein, a method performed by a receiver in a communication system, comprises: acquiring configuration information of a reference signal for positioning: performing a carrier phase-based positioning measurement based on the configuration information: and reporting and/or transmitting a result of the carrier phase-based positioning measurement.

### TECHNICAL FIELD

The present disclosure generally relates to the field of communications. more specifically, the present disclosure relates to method and apparatus for measuring positioning reference signal in a wireless communication system.

### BACKGROUND ART

5G mobile communication technologies define broad frequency bands such that high transmission rates and new services are possible, and can be implemented not only in “Sub 6 GHZ” bands such as 3.5 GHZ, but also in “Above 6 GHZ” bands referred to as mmWave including 28 GHZ and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to wireless communication systems and, more specifically, the present disclosure relates to method and apparatus for performing a receiver in a wireless communication system.

### Solution to Problem

According to one aspect of the present disclosure, there is provided a method performed by a receiver in a wireless communication system. The method may include acquiring configuration information of a reference signal for positioning, performing a carrier phase-based positioning measurement based on the configuration information, and reporting and/or transmitting a result of the carrier phase-based positioning measurement.

In one embodiment, in the above-described method performed by the receiver: in a case where a condition for enabling the carrier phase-based positioning measurement is satisfied, the carrier phase-based positioning measurement may be performed.

In one embodiment, in the above-described method performed by the receiver, the condition may include a combination of one or more of items below: a difference value between reference signal receiving power RSRPs of a strongest path and a second path of the reference signal for positioning received by the receiver is greater than a first threshold value; the reference signal for positioning received by the receiver has N paths whose RSRP values are greater than a second threshold value, wherein, N is an integer greater than or equal to 1; a Light of Sight/Non-Light of Sight (LOS/NLOS) indication signal is a hard value and the value is 1 or true, and/or the LOS/NLOS indication signal is a soft value and the value is greater than a fourth threshold value; and a multipath indication signal indicates that the reference signal for positioning is a single-path signal.

In one embodiment, in the above-described method performed by the receiver, when a second condition is satisfied, the multipath indication signal indicates that the reference signal for positioning is a single-path signal, and the second condition may include a combination of one or more of items below: a difference value between reference signal receiving power RSRPs of a strongest path and a second path of the reference signal for positioning received by the receiver is greater than a first threshold value; the reference signal for positioning received by the receiver has N paths whose RSRP values are greater than a second threshold value, wherein, N is an integer greater than or equal to 1; an LOS/NLOS indication signal is a hard value and the value is 1 or true, and/or the LOS/NLOS indication signal is a soft value and the value is greater than a fourth threshold value.

In one embodiment, the above-described method performed by the receiver may further include: transmitting, to a transmitter, first assistance information, which is used for configuring the reference signal for positioning.

In one embodiment, the above-described method performed by the receiver may further include: keeping synchronization with a clock of the transmitter.

In one embodiment, in the above-described method performed by the receiver, the keeping synchronization with the clock of the transmitter may include a combination of one or more of items below: keeping synchronization with the clock of the transmitter according to a clock of an absolute time source, and keeping synchronization with the clock of the transmitter through a clock synchronization timestamp.

In one embodiment, in the above-described method performed by the receiver, the first assistance information may include at least one of a subcarrier spacing of reference signal for positioning, a time-frequency resource location of reference signal for positioning, a port and a bandwidth of reference signal for positioning, a transmission period of reference signal for positioning, a duration of reference signal for positioning, a start point of reference signal for positioning, a repetition period and a muting mechanism of reference signal for positioning.

In one embodiment, in the above-described method performed by the receiver, the keeping synchronization with the clock of the transmitter through the clock synchronization timestamp may include: receiving the clock synchronization timestamp configured by the transmitter, wherein, the clock synchronization timestamp may include: a transmission time associated with an identity ID of a specific reference signal for positioning; and the receiver may use a difference value between the transmission time in the received clock synchronization timestamp and a local reception time of the reference signal associated with the identity ID of the specific reference signal for positioning as transmission time of the reference signal for positioning, to complete synchronization with the transmitter.

In one embodiment, in the above-described method performed by the receiver, when the first condition is satisfied, the clocks of the transmitter and the receiver are to be kept synchronized.

In one embodiment, in the above-described method performed by the receiver, the first condition may be that a positioning accuracy is less than a fifth threshold value and/or the RSRP of the reference signal for positioning received by the receiver is less than a sixth threshold value.

In one embodiment, the above-described method performed by the receiver may further include: compensating for a residual carrier phase shift.

In one embodiment, in the above-described method performed by the receiver, the compensating for the residual carrier phase shift may include a combination of one or more of items below: when performing the carrier phase-based positioning measurement through a single carrier and/or multiple carriers, the receiver may receive the reference signal for positioning through P consecutive OFDM symbols, and/or may receive the reference signal for positioning through an OFDM symbol group, wherein, the OFDM symbol group may include consecutive OFDM symbols; the receiver may separate the residual carrier phase shift by means of frequency hopping; the receiver may receive the reference signal for positioning q times, and compensate for the residual carrier phase shift by statistical means, wherein, q is an integer greater than or equal to 1.

In one embodiment, in the above-described method performed by the receiver, when a transmission time gap of the reference signal for positioning is less than a seventh threshold value and/or when a positioning measurement accuracy requirement is satisfied, the receiver may receive the reference signal for positioning q times.

In one embodiment, in the above-described method performed by the receiver, the reported and/or transmitted result of carrier phase-based positioning measurement may include at least one of items below: a carrier phase measurement result, a reference signal time difference RSTD.

In one embodiment, in the above-described method performed by the receiver, the carrier phase measurement result may include at least one of items below: an integer part carrier phase difference between the receiver and the transmitter, a fractional part carrier phase difference between the receiver and the transmitter, an integer part carrier phase difference between a current carrier phase measurement and a last carrier phase measurement, and a fractional part carrier phase difference between the current carrier phase measurement and the last carrier phase measurement.

In one embodiment, in the above-described method performed by the receiver, when no phase jumping is detected and/or the RSRP value of the received reference signal for positioning is greater than or equal to an eighth threshold value and/or a positioning accuracy is greater than or equal to a ninth threshold value, the carrier phase measurement result may include the integer part carrier phase difference and/or the fractional part carrier phase difference between the current carrier phase measurement and the last carrier phase measurement; or when a phase jumping is detected and/or the RSRP value of the received reference signal for positioning is less than the eighth threshold value and/or the positioning accuracy is less than the ninth threshold value, the carrier phase measurement result may include the integer part carrier phase difference and/or the fractional part carrier phase difference between the receiver and the transmitter.

In one embodiment, in the above-described method performed by the receiver, the RSTD may be obtained according to the carrier phase difference measured by using the carrier phase-based positioning measurement method and/or obtained through a result based on the Time Difference of Arrival TDOA measurement method that is corrected by a result of the carrier phase-based positioning measurement method.

In one embodiment, in the above-described method performed by the receiver, at least one threshold value of the first threshold value, the second threshold value, the fourth threshold value, the fifth threshold value, the sixth threshold value, the seventh threshold value, the eighth threshold value, and the ninth threshold value may be a value determined by a user equipment UE and/or a value configured by the base station.

In one embodiment, in the above-described method performed by the receiver, the configuration information of the reference signal for positioning may be specific configuration information of a reference signal for carrier phase positioning.

In one embodiment, in the above-described method performed by the receiver, in a case where the reference signal for positioning is transmitted by using a timing advance method, the RSTD may be determined based on a timing advance time and a clock offset error between the receiver and the transmitter; or in a case where the reference signal for positioning is not transmitted by using the timing advance method, the RSTD may be determined based on the clock offset error between the receiver and the transmitter.

In one embodiment, in the above-described method performed by the receiver, the strongest path may be a first arrival path and/or a first detection path of the reference signal for positioning in time and/or a path of the reference signal for positioning whose RSRP value is the largest.

In one embodiment, in the above-described method performed by the receiver, the second path may be a second arrival path and/or a second detection path of the reference signal for positioning in time and/or a path of the reference signal for positioning whose RSRP value is the next largest.

According to another aspect of the present disclosure, there is further provided a method performed by a transmitter in a communication system. The method may include: configuring a reference signal for positioning and/or determining a reference signal for positioning according to configuration information; transmitting, to a receiver, configuration information of the reference signal for positioning, and/or transmitting, to the receiver, the reference signal for positioning; and receiving, from the receiver, a result of a carrier phase-based positioning measurement.

In one embodiment, in the above-described method performed by the transmitter, the reference signal for positioning may be configured and/or determined according to first assistance information received from the receiver; and/or a spacing of the reference signal for positioning in a frequency domain may be calculated according to a coverage range of the transmitter; and/or the reference signal for positioning may be transmitted by using a timing advance method or not by using a timing advance method.

In one embodiment, in the above-described method performed by the transmitter, the receiver may be a user equipment UE, a base station, a location management function LMF, or a sidelink device; and/or the transmitter may be a user equipment UE, a base station, a location management function LMF, or a sidelink device.

According to another aspect of the present disclosure, there is provided a transmitter device. The transmitter device may include a transceiver; and a processor, coupled to the transceiver and configured to perform any one of the above-described methods performed by the transmitter.

According to another aspect of the present disclosure, there is provided a receiver device. The receiver device may include: a transceiver; and a processor, coupled to the transceiver and configured to perform any one of the above-described methods performed by the receiver.

According to another aspect of the present disclosure, there is further provided a non-transitory computer-readable medium, having instructions stored thereon, and when the instructions are executed by a processor, causing the processor to perform the above-described methods.

### Advantageous Effects of Invention

Aspects of the present disclosure provide efficient communication methods in a wireless communication system.

### BRIEF DESCRIPTION OF DRAWINGS

FIG. 1 illustrates an an exemplary wireless network according to various embodiments of the present disclosure;

FIG. 2A illustrates an exemplary wireless transmitting and receiving paths according to the present disclosure;

FIG. 2B illustrates an exemplary wireless transmitting and receiving paths according to the present disclosure;

FIG. 3A illustrates an exemplary UE according to the present disclosure;

FIG. 3B illustrates an exemplary gNB according to the present disclosure;

FIG. 4 illustrates an exemplary measurement flowchart according to an exemplary embodiment of the present disclosure;

FIG. 5 illustrates an example of small-range frequency hopping and large-range frequency hopping according to the present disclosure;

FIG. 6 illustrates a block diagram of a terminal (or a user equipment (UE), according to embodiments of the present disclosure; and

FIG. 7 illustrates a block diagram of a base station, according to embodiments of the present disclosure.

### BEST MODE FOR CARRYING OUT THE INVENTION

Accordingly, the embodiment herein is to provide a method performed by a receiver in a wireless communication system. The method includes acquiring configuration information of a reference signal for positioning. Further, the method includes performing a carrier phase-based positioning measurement based on the configuration information. Further, the method includes reporting and/or transmitting a result of the carrier phase-based positioning measurement.

In an embodiment, in a case where a condition for enabling the carrier phase-based positioning measurement is satisfied, the carrier phase-based positioning measurement is performed.

In an embodiment, the condition comprises a combination of one or more of items below: a difference value between reference signal receiving power RSRPs of a strongest path and a second path of the reference signal for positioning received by the receiver is greater than a first threshold value, the reference signal for positioning received by the receiver has N paths whose RSRP values are greater than a second threshold value, wherein, N is an integer greater than or equal to 1, a Light of Sight/Non-Light of Sight indication signal is a hard value and the value is 1 or true, and/or the Light of Sight/Non-Light of Sight indication signal is a soft value and the value is greater than a fourth threshold value, and a multipath indication signal indicates that the reference signal for positioning is a single-path signal.

In an embodiment, when a second condition is satisfied, the multipath indication signal indicates that the reference signal for positioning is a single-path signal. Further, the second condition comprises a combination of one or more of items below: a difference value between reference signal receiving power RSRPs of the strongest path and the second path of the reference signal for positioning received by the receiver is greater than the first threshold value, the reference signal for positioning received by the receiver has N paths whose RSRP values are greater than the second threshold value, wherein, N is an integer greater than or equal to 1, and the Light of Sight/Non-Light of Sight indication signal is a hard value and the value is 1 or true, and/or the Light of Sight/Non-Light of Sight indication signal is a soft value and the value is greater than the fourth threshold value.

In an embodiment, the receiver further includes keeping synchronization with a clock of a transmitter.

In an embodiment, the keeping synchronization with the clock of the transmitter comprises a combination of one or more of items below: keeping synchronization with the clock of the transmitter according to a clock of an absolute time source and keeping synchronization with the clock of the transmitter through a clock synchronization timestamp.

In an embodiment, the receiver further includes compensating for a residual carrier phase shift.

In an embodiment, the compensating for the residual carrier phase shift comprises a combination of one or more of items below: when performing the carrier phase-based positioning measurement through a single carrier and/or multiple carriers, the receiver receives the reference signal for positioning through P consecutive OFDM symbols, and/or receives the reference signal for positioning through an OFDM symbol group, wherein, the OFDM symbol group comprises consecutive OFDM symbols, the receiver separates the residual carrier phase shift by means of frequency hopping, and the receiver receives the reference signal for positionig q times, and compensates for the residual carrier phase shift by statistical means, wherein, q is an integer greater than or equal to 1.

In an embodiment, when a transmission time gap of the reference signal for positioning is less than a seventh threshold value and/or when a positioning measurement accuracy requirement is satisfied, the receiver receives the reference signal for positioning q times.

In an embodiment, the reported and/or transmitted result of the carrier phase-based positioning measurement comprises at least one of items below: a carrier phase measurement result and a reference signal time difference RSTD.

In an embodiment, the carrier phase measurement result comprises at least one of items below: an integer part carrier phase difference between the receiver and the transmitter, a fractional part carrier phase difference between the receiver and the transmitter, an integer part carrier phase difference between a current carrier phase measurement and a last carrier phase measurement, and a fractional part carrier phase difference between the current carrier phase measurement and the last carrier phase measurement.

In an embodiment, when no phase jumping is detected and/or a RSRP value of the received reference signal for positioning is greater than or equal to an eighth threshold value and/or a positioning accuracy is greater than or equal to a ninth threshold value, the carrier phase measurement result comprises the integer part carrier phase difference and/or the fractional part carrier phase difference between the current carrier phase measurement and the last carrier phase measurement, or when phase jumping is detected and/or the RSRP value of the received reference signal for positioning is less than the eighth threshold value and/or the positioning accuracy is less than the ninth threshold value, the carrier phase measurement result comprises the integer part carrier phase difference and/or the fractional part carrier phase difference between the receiver and the transmitter.

In an embodiment, the RSTD is obtained according to the carrier phase difference measured by using the carrier phase-based positioning measurement method, and/or obtained through a result based on the Time Difference of Arrival TDOA measurement method that is corrected by a result of the carrier phase-based positioning measurement method.

In an embodiment, the configuration information of the reference signal for positioning is specific configuration information of a reference signal for carrier phase positioning.

In an embodiment, in a case where the reference signal for positioning is transmitted by using a timing advance method, the RSTD is determined based on a timing advance time and a clock offset error between the receiver and the transmitter, or in a case where the reference signal for positioning is not transmitted by using the timing advance method, the RSTD is determined based on the clock offset error between the receiver and the transmitter.

Accordingly, the embodiment herein is to provide a method performed by a transmitter in a communication system. The method includes configuring a reference signal for positioning and/or determining the reference signal for positioning according to configuration information. Further, the method includes transmitting, to a receiver, configuration information of the reference signal for positioning, and/or transmitting, to the receiver, the reference signal for positioning. Further, the method includes receiving, from the receiver, a result of a carrier phase-based positioning measurement.

In an embodiment, the reference signal for positioning is configured and/or determined according to first assistance information received from the receiver, and/or a spacing of the reference signal for positioning in a frequency domain is calculated according to a coverage range of the transmitter, and/or the reference signal for positioning is transmitted by using a timing advance method or not by using the timing advance method.

In an embodiment, the receiver is a user equipment UE, a base station, a location management function LMF, or a sidelink device and/or the transmitter is a UE, a base station, an LMF, or a sidelink device.

Accordingly, the embodiment herein is to provide a transmitter device or a receiver device. The transmitter device or the receiver device include a transceiver and a processor, coupled to the transceiver and configured to perform the method.

### Mode for the Invention

The following description with reference to the accompanying drawings is provided to facilitate comprehensive understanding of various embodiments of the present disclosure as defined by the claims and equivalents thereof. The description includes various specific details to facilitate understanding, but should be considered exemplary only. Therefore, those ordinarily skilled in the art will recognize that, various changes and modifications may be made to the various embodiments described herein without departing from the scope and spirit of the present disclosure. In addition, for clarity and conciseness, description of well-known functions and structures may be omitted.

The terms and wordings used in the following description and claims are not limited to their dictionary meaning, but are merely used by an inventor to enable a clear and consistent understanding of the present disclosure. Therefore, it should be apparent to those skilled in the art that, the following description of various embodiments of the present disclosure is provided for illustration purposes only and not for the purpose of limiting the scope of the present disclosure as defined by the appended claims and equivalents thereof.

It should be understood that, the singular forms of “a”, “an” and “the” include plural references unless the context clearly dictates otherwise. Thus, for example, a reference to a “component surface” includes a reference to one or more such surfaces.

The terms “include” or “may include” refer to presence of a correspondingly disclosed function, operation, or component that may be used in various embodiments of the present disclosure, rather than limiting presence of one or more additional functions, operations, or features. Furthermore, the terms “comprise” or “have” may be construed to indicate certain characteristics, numbers, steps, operations, constituent elements, components, or combinations thereof, but should not be construed as excluding possibility of presence of one or more other characteristics, numbers, steps, operations, constituent elements, components, or combinations thereof.

The term “or” as used in various embodiments of the present disclosure includes any of the listed terms and all combinations thereof. For example, “A or B” may include A, or may include B, or may include both A and B.

Unless defined differently, all terms (including technical or scientific terms) used in the present disclosure have the same meaning as understood by those ordinarily skilled in the art according to the present disclosure. Common terms as defined in dictionaries are to be construed to have meanings consistent with the context in the relevant technical field, and should not be construed ideally or overly formalized unless explicitly so defined in the present disclosure.

The technical solutions of the embodiments of the present disclosure may be applied to various communication systems, for example: Global System for Mobile communications (GSM) system, Code Division Multiple Access (CDMA) system, Wideband Code Division Multiple Access (WCDMA) system, General Packet Radio Service (GPRS), Long Term Evolution (LTE) system, LTE Frequency Division Duplex (FDD) system, LTE Time Division Duplex (TDD), Universal Mobile Telecommunication System (UMTS), Worldwide interoperability for Microwave Access (WiMAX) communication system, 5th generation (5G) system or New Radio (NR), etc. In addition, the technical solutions of the embodiments of the present disclosure may be applied to future-oriented communication technologies.

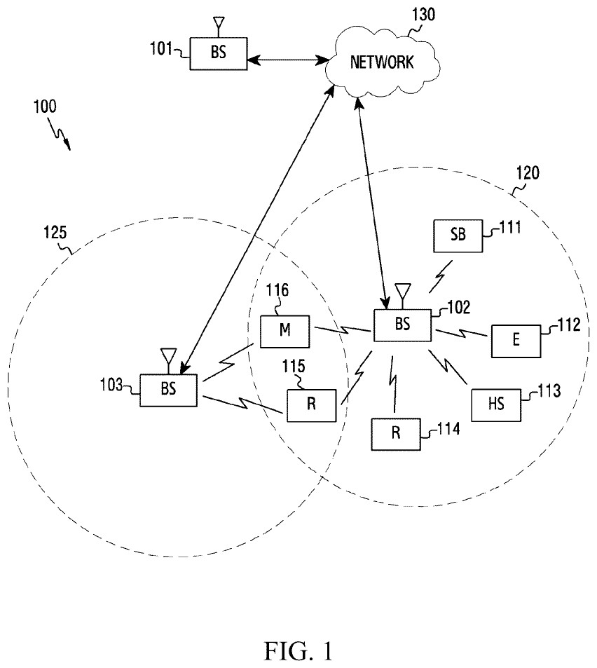

FIG. 1 illustrates an example wireless network 100 according to various embodiments of the present disclosure. The embodiment of the wireless network 100 shown in FIG. 1 is for illustration only. Other embodiments of the wireless network 100 may be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” may be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” may be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101 through 103 can communicate with each other and with UEs 111 through 116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes may be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102 through 103 can directly communicate with the network 130 and provide direct wireless broadband access to the network 130 for the UEs. In addition, gNB 101, 102 and/or 103 can provide access to other or additional external networks, such as external telephone networks or other types of data networks.

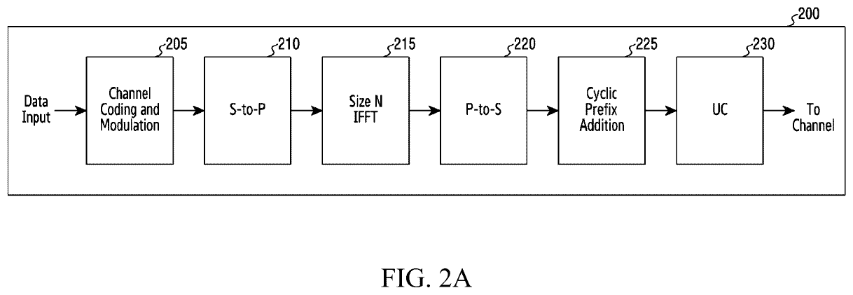

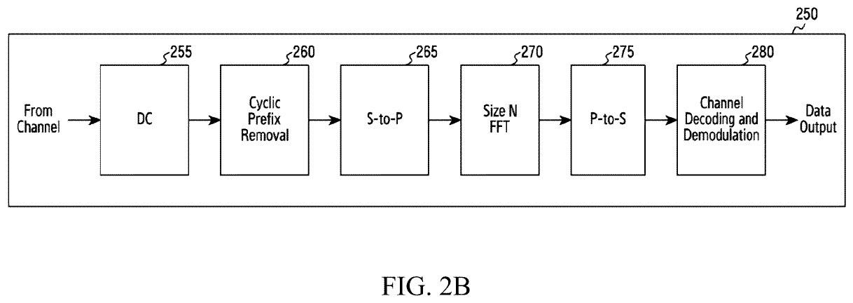

FIG. 2A illustrates an example wireless transmission and reception paths according to the present disclosure. In the following description, the transmission path 200 may be described as being implemented in a gNB, such as gNB 102.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

FIG. 2B illustrates an example wireless transmission and reception paths according to the present disclosure. In the following description, the reception path 250 may be described as being implemented in a UE, such as UE 116. However, it should be understood that the reception path 250 may be implemented in a gNB. In some embodiments, the reception path 250 is configured to support codebook designs and structures for systems with 2D antenna arrays as described in embodiments of the present disclosure.

The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

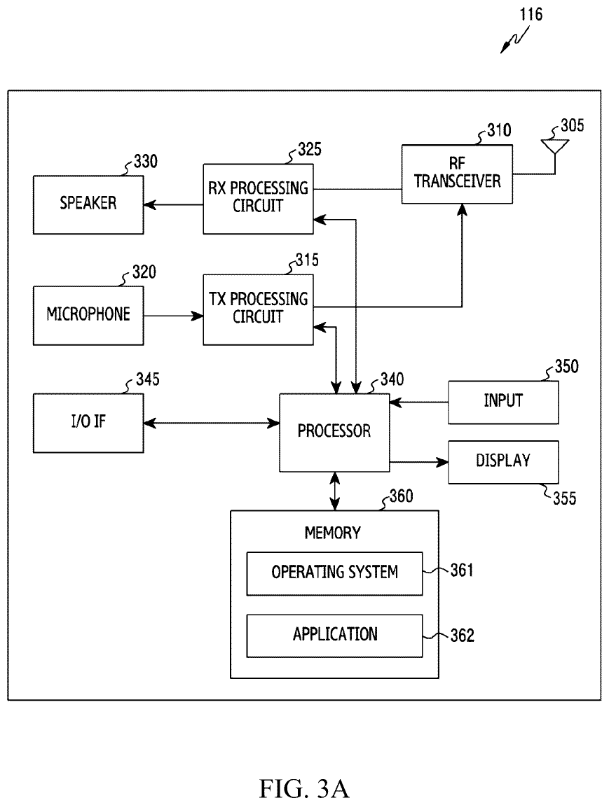

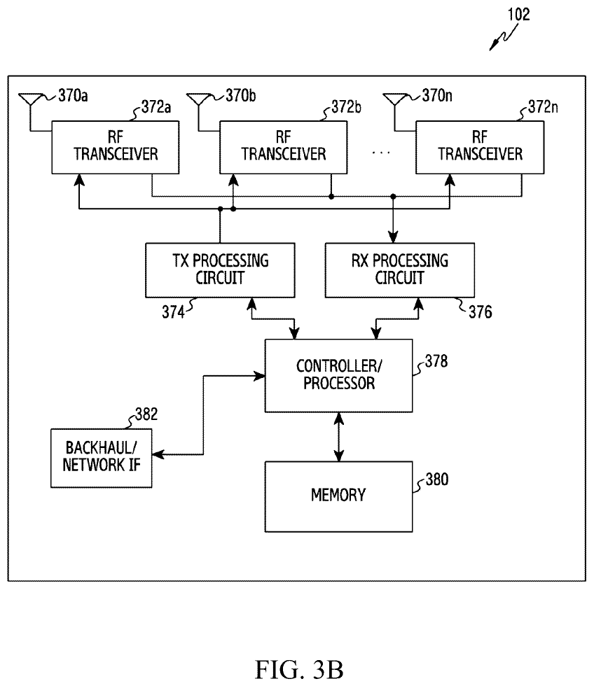

FIG. 3A illustrates an example UE 116 according to the present disclosure. The embodiment of UE 116 shown in FIG. 3A is for illustration only, and UEs 111 through 115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although

FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a through 370n, a plurality of RF transceivers 372a through 372n, a transmission (TX) processing circuit 374, and a reception (RX) processing circuit 376. In certain embodiments, one or more of the plurality of antennas 370a through 370n include a 2D antenna array. gNB 102 also includes a controller/processor 378, a memory 380, and a backhaul or network interface 382.

RF transceivers 372a through 372n receive an incoming RF signal from antennas 370a through 370n, such as a signal transmitted by UEs or other gNBs. RF transceivers 372a through 372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a through 372n receive the outgoing processed baseband or IF signal from TX processing circuit 374 and up-convert the baseband or IF signal into an RF signal transmitted via antennas 370a through 370n.

The controller/processor 378 can include one or more processors or other processing devices that control the overall operation of gNB 102. For example, the controller/processor 378 can control the reception of forward channel signals and the transmission of backward channel signals through the RF transceivers 372a through 372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a through 372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also referred to as a time unit) in the present disclosure may be: one OFDM symbol, one OFDM symbol group (composed of a plurality of OFDM symbols), one slot, one slot group (composed of a plurality of slots), one subframe, one subframe group (composed of a plurality of subframes), one system frame, one system frame group (composed of a plurality of system frames); or may also be an absolute time unit, for example, 1 millisecond, 1 second, etc.; the time domain unit may also be a combination of various granularities, for example, N1 slots plus N2 OFDM symbols, wherein, N1 and N2 may be natural numbers.

A frequency domain unit (also referred to as a frequency unit) in the present disclosure may be: one subcarrier, one subcarrier group (composed of a plurality of subcarriers), one Resource Block (RB), which may also be referred to as a Physical Resource Block (PRB), one resource block group (composed of a plurality of RBs), one frequency band part (also referred to as BandWidth Part (BWP)), one frequency band part group (composed of a plurality of BWPs)), one frequency band/carrier, one frequency band group/carrier group; or may also be an absolute frequency unit, for example, 1 Hz, 1 kHz, etc.; the frequency domain unit may also be a combination of various granularities, for example, M1 PRBs plus M2 subcarriers, wherein, M1 and M2 may be natural numbers.

Exemplary embodiments of the present disclosure are further described below in conjunction with the accompanying drawings.

The text and drawings are provided by way of examples only to assist the reader in understanding the present disclosure. They are not intended and should not be construed to limit the scope of the present disclosure in any way. Although certain embodiments and examples have been provided, it will be apparent to those skilled in the art based on the disclosure herein that the shown embodiments and examples may be modified without departing from the scope of the present disclosure.

Transmission links in the wireless communication system mainly includes: a downlink communication link from a gNB to a User Equipment (UE), and an uplink communication link from a UE to a network.

Nodes for positioning measurement (also referred to as location measurement) in the wireless communication system (c.g., a current wireless communication system) may include: a UE for initiating a positioning request message, a Location Management Function (LMF) for issuance of positioning assistance data and UE positioning, a gNB or Transmission-Reception Point (TRP) for broadcasting positioning assistance data and uplink positioning measurement, and a UE for downlink positioning measurement.

In a process of performing positioning measurement, the transmitter transmits a reference signal for positioning; the receiver measures the reference signal for positioning, calculates and reports a positioning measurement result, or reports assistance information to the transmitter, and the transmitter calculates the positioning measurement result.

In order to provide positioning services of higher accuracy and lower latency, a carrier phase-based positioning measurement method may be used to further reduce a positioning measurement error. The carrier phase-based positioning measurement method implements positioning measurement by detecting a change (e.g., a difference value) between carrier phases of the transmitter and the receiver. Wherein the difference value between the carrier phases of the transmitter and the receiver may be divided into two portions: an integer part carrier phase difference and a fractional part carrier phase difference (of a carrier cycle). As compared with a positioning measurement method using Time Difference of Arrival (TDOA) (hereinafter briefly referred to as a TDOA method or a TDOA measurement method), the carrier phase-based positioning measurement method is not limited by time domain sampling frequency; and because it neither requires oversampling nor requires an interpolation process, it is simpler than the TDOA method. However, considering that the reference signal for positioning is affected by a multipath effect and Doppler frequency shift during a propagation process, the reference signal for positioning may have serious phase shift occur at the transmitter and the receiver, which, in extreme cases, will lead to phase jumping, that is, a cycle slip phenomenon. The above-described problems have brought great difficulties to positioning measurement using the carrier phase; and how to implement carrier phase-based positioning measurement in a rich-scatter environment is a problem that needs to be solved.

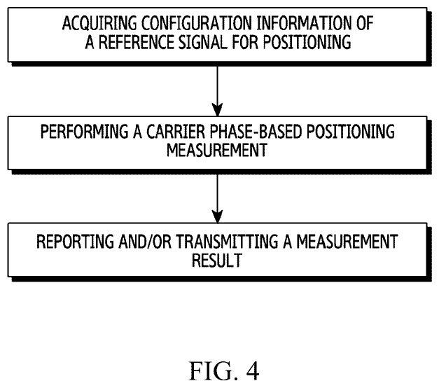

FIG. 4 illustrates an exemplary measurement flow according to an exemplary embodiment of the present disclosure. Specifically, in the present disclosure, a method and a device for measuring a signal will be introduced, including but not limited to a method and a device for measuring a reference signal for positioning. In this embodiment, as shown in FIG. 4, four methods below will be introduced a method for configuring a reference signal for measuring a carrier phase (as a result, a receiver may receive and/or acquire, from a transmitter, configuration information of the reference signal for positioning), a method for determining (or judging) whether conditions for enabling a carrier phase-based positioning measurement method are satisfied, a method for performing a carrier phase-based positioning measurement, and a method for reporting and/or transmitting a measurement result, to implement the carrier phase-based positioning measurement. In the present disclosure, the exemplary method is introduced by using Positioning Reference Signals (PRS), and Sounding Reference Signal-Position (SRS-POS) as non-limiting examples of the reference signal for positioning; and the introduced method may also be used for measurement of other signals.

When using PRS and/or SRS-POS for the carrier phase-based positioning measurement, the configuration method for the above-described reference signal for positioning may include a combination of one or more of items below:
A base station configures a reference signal for positioning, for example, the base station configures, for the UE, a reference signal for positioning. For example, the UE receives, from the base station, configuration information of the reference signal for positioning. In some embodiments, in a case where the reference signal for positioning is a PRS, the configuration information for the PRS may include at least one of items below: a subcarrier spacing of the PRS, a time-frequency resource location of the PRS, a port and a bandwidth of the PRS, a transmission period of the PRS, a duration of the PRS, a start point of the PRS, a repetition period and a muting mechanism of the PRS, etc.; similarly, in some embodiments, in a case where the reference signal for positioning is a SRS-POS, the configuration information for the SRS-POS may include at least one of items below: a subcarrier spacing of the SRS-POS, a time-frequency resource location of the SRS-POS, a port and a bandwidth of the SRS-POS, a transmission period of the SRS-POS, a duration of the SRS-POS, a start point of the SRS-POS, a repetition period and a muting mechanism of the SRS-POS, etc.; in one embodiment, the configuration information of the reference signal for positioning may be specific configuration information of a reference signal for carrier phase positioning.
The receiver transmits, to the transmitter, first assistance information, which is used for configuration of the above-described reference signal for positioning; for example, the first assistance information provides optional configuration parameters (and/or configuration information) of the reference signal for positioning; the transmitter may determine configuration information, for example, for the PRS, according to the first assistance information provided by the receiver, and transmit, to the receiver, the determined configuration information for the PRS. For example, the receiver may transmit, to the transmitter, configuration information of a suggested PRS or SRS-POS transmission period, for positioning measurement. Of course, when the transmitter determines and/or configures the reference signal for positioning (and/or the configuration information of the reference signal for positioning), it may base on some or all of the information in the first assistance information, or may not base on the first assistance information.
Optionally, the first assistance information may include at least one of a subcarrier spacing, a time-frequency resource location, a port and a bandwidth, a transmission period, a duration, a start point, a repetition period, and a muting mechanism of the PRS and/or SRS-POS; the above-described parameters are only examples, but are not limited thereto.
Optionally, when the carrier phase-based positioning measurement method is used for positioning measurement, a coverage range d of the transmitter is related to a spacing (e.g., a comb size) K_{comb}^{PRS} of reference signal for positioning in a frequency domain given by a higher layer parameter dl-PRS-CombSizeN. For example, a value of K_{comb}^{PRS} should be calculated according to the coverage range d of the transmitter. For example, the value of K_{comb}^{PRS} is equal to c/(Δf*d), wherein, c is a propagation speed of light, which is equal to 3*10⁸ m/s, and Δf is the subcarrier spacing; those skilled in the art should understand that, although the parameter K_{comb}^{PRS} related to PRS is described above as an example, yet the method for calculating the spacing of the reference signal for positioning (e.g., SRS-POS) in the frequency domain according to the coverage range of the transmitter is also considered within the scope of the present disclosure.
A transmission mode of the reference signal for positioning may be indicated through indication information (e.g., downlink control information DCI, radio resource control RRC information, downlink media access control control element MAC CE information, long-term evolution LTE positioning protocol LPP information, etc.). Optionally, the transmission mode of the reference signal for positioning (e.g., the uplink positioning reference signal SRS-POS and/or the positioning reference signal PRS) may include a combination of one or more of items below:
The reference signal for positioning (e.g., the SRS-POS for uplink positioning measurement and/or the PRS for downlink positioning measurement) is transmitted by using a timing advance method, so that time when the signal arrives at the receiver is not influenced by a distance between the transmitter and the receiver.
The reference signal for positioning (e.g., the SRS-POS for uplink positioning measurement and/or the PRS for downlink positioning measurement) is not transmitted by using the timing advance method, so that influence of timing advance on the TDOA positioning measurement method may be reduced.
The receiver may be a UE or a base station or an LMF or a sidelink device (e.g., a device supporting a sidelink); and the transmitter may be a UE or a base station or an LMF or a sidelink device (e.g., a device supporting a sidelink).

Optionally, after configuring the reference signal for carrier phase positioning, the receiver judges whether the conditions for enabling the carrier phase-based positioning measurement method are satisfied; and when the conditions are satisfied, the carrier phase-based positioning measurement method may be used for positioning measurement; otherwise, the carrier phase-based positioning measurement method may not be used for positioning measurement. The conditions may include a combination of one or more of items below:
A first threshold value L1 is set; when a difference value between Reference Signal Receiving Power (RSRPs) of a strongest path and a second path of the reference signal for positioning received by the receiver is greater than the first threshold value L1, the receiver considers that the reference signal for positioning is propagated through a single path; at this time, the carrier phase-based positioning measurement method may be used for positioning measurement. Wherein, L1 may be a real number greater than 0.
A second threshold value L2 is set; when the reference signal for positioning received by the receiver has N paths whose RSRP value is greater than the second threshold value L2, the receiver considers that the reference signal for positioning is propagated through a single path; at this time, the carrier phase-based positioning measurement method may be used for positioning measurement. Wherein, L2 may be a real number greater than 0, and N may be an integer greater than or equal to 1. Optionally, when the reference signal for positioning received by the receiver has one path, N=1. Optionally, when a time range for receiving the reference signal for positioning by the receiver is less than a third threshold value (within a same cluster), N is an integer greater than or equal to 1. In some implementations, when the reference signal for positioning received by the receiver has M paths or M clusters which are greater than the second threshold value L2 and M>N, the receiver may consider that the reference signal for positioning is propagated through multiple paths, and may consider that the environment in which the reference signal for positioning is propagated is a multipath environment.
When a Light of Sight/Non-Light of Sight indication signal (e.g., LOS/NLOS indicator) is a hard value indicator and the value is “1” or “true”, and/or when the Light of Sight/Non-Light of Sight indication signal (e.g., LOS/NLOS indicator) is a soft value indicator and the value is greater than a fourth threshold value L4, the carrier phase-based positioning measurement method may be performed for positioning measurement, wherein, L4 may be a real number greater than 0; optionally, L4 may be equal to 0.5; and those skilled in the art should understand that, the value of L4 is not limited thereto.
The transmitter and/or the receiver determine whether to enable the carrier phase-based positioning measurement method according to a multipath indication signal (e.g., a multipath indicator). The multipath indication signal may be used to indicate whether the reference signal for positioning measurement is propagated through multiple paths or a single path; and as a non-limiting example, the method for judging whether the reference signal for positioning is propagated through multiple paths or a single path (the reference signal for positioning is a single-path signal or a propagation channel of the reference signal for positioning is a single-path channel) may include a combination of one or more of items below:
A first threshold value L1 is set; when a difference value between RSRPs of a strongest path and a second path of the reference signal for positioning received by the receiver is greater than the first threshold value L1, the multipath indication signal is set to a specific value, for example, but not limited to, “0” or “false” (in other implementations, the specific value may be “1” or “true”), to indicate that the receiver considers that the reference signal for positioning is propagated through a single path, wherein, L1 may be a real number greater than 0.
A second threshold value L2 is set; when the reference signal for positioning received by the receiver has N paths whose RSRP value is greater than the second threshold value L2, the multipath indication signal is set to a specific value, for example, but not limited to “0” or “false” (in other implementations, the specific value may be “1” or “true”), which indicates that the receiver considers that the reference signal for positioning is propagated through a single path. Wherein, L2 may be a real number greater than 0, and N may be an integer greater than or equal to 1. Optionally, when the reference signal for positioning received by the receiver has one path, N=1. Optionally, when a time range for receiving the reference signal for positioning by the receiver is less than the third threshold value (within a same cluster), N is an integer greater than or equal to 1. In some implementations, when the reference signal for positioning received by the receiver has M paths or M clusters which are greater than the second threshold value L2 and M>N, the receiver may consider that the reference signal for positioning is propagated through multiple paths, and may consider that the environment in which the reference signal for positioning is propagated is a multipath environment, and at this time, the multipath indication signal may be set to “1” For example, when the receiver sets the multipath indication signal to “0” according to the method for judging whether the reference signal for positioning is propagated through multiple paths or a single path, the transmitter and/or the receiver may consider that the reference signal for positioning is propagated through a single path; and at this time, the carrier phase-based positioning measurement method may be used for positioning measurement.
The receiver may be a UE or a base station or an LMF or a sidelink device (e.g., a device supporting a sidelink); and the transmitter may be a UE or a base station or an LMF or a sidelink device (e.g., a device supporting a sidelink).
The strongest path may be a first arrival path and/or a first detection path of the reference signal in time and/or a path of the reference signal whose RSRP value is the largest; and the second path may be a second arrival path and/or a second detection path of the reference signal in time and/or a path of the reference signal whose RSRP value is the second largest.
The first threshold value and/or the second threshold value and/or the third threshold value and/or the fourth threshold value may be a parameter value subject to user equipment UE capability, and/or a parameter value configured by the base station (e.g., a parameter value configured by the base station that is received by the UE), and/or a preconfigured parameter value.
Optionally, the reference signal for positioning measurement may be a received reference signal for positioning measurement.

Those skilled in the art should understand that, although the RSRP of the reference signal is taken as an example to describe the parameter used to determine whether to enable the carrier phase-based positioning measurement method above, yet parameters such as the Reference Signal Receiving Quality (RSRQ), Received Signal Strength Indication (RSSI), etc. of the reference signal may also be used when judging whether to enable the carrier phase-based positioning measurement method, without departing from the scope of the present disclosure.

Based on any one of the above-described embodiments, ensuring synchronization of the clocks of the transmitter and the receiver may reduce carrier phase shift caused by clock offset. Therefore, optionally, the method may further include keeping the clocks of the transmitter and the receiver synchronized. For example, when the first condition is satisfied, the clocks of the transmitter and the receiver are to be kept synchronized.

In some embodiments, the manner for keeping the clocks of the transmitter and the receiver synchronized may include a combination of one or more of items below:
Using a clock of an absolute time source to ensure synchronization of the clocks of the transmitter and the receiver. The transmitter and the receiver are synchronized with a same absolute time source; the absolute time source may be a system with fixed time such as a Global Navigation Satellite System (GNSS), a Global Positioning System (GPS), etc. in order to reduce phase shift caused by Sampling Clock Offset (SCO), and ensure synchronization of the clocks of the transmitter and the receiver. In some implementations, for example, the transmitter and the receiver may periodically transmit synchronization requests to the absolute time source, or the transmitter and the receiver may transmit synchronization requests to the absolute time source when the first condition is satisfied, and calibrates current device time according to synchronization time issued by the absolute time source, so as to ensure that the receiver and the transmitter are kept in synchronized state.
Using clock synchronization timestamps to ensure synchronization of the clocks of the receiver and the transmitter. The clock synchronization timestamp may contain a transmission time of the reference signal for positioning. The clock synchronization timestamp is associated with a specific (or unique) identity ID of the reference signal for positioning, to ensure that the positioning reference signal for performing measurement associated with the specific ID of the reference signal for positioning corresponds to one unique transmission time. For example, the clock synchronization timestamp may contain a transmission time and identity ID of the reference signal for positioning, for example, identity ID of the reference signal for positioning can be a dl-PRS-ID and/or a nr-DL-PRS-ResourceSetID and/or a nr-DL-PRS-ResourceID-r16 of the positioning reference signal and/or a repetition index value of a PRS resource; a value range of the repetition index value of the PRS resource may be 1 to a dl-PRS-ResourceRepetitionFactor (a parameter configured by a higher layer). One unique PRS may be determined by the dl-PRS-ID and/or nr-DL-PRS-ResourceSetID and/or nr-DL-PRS-ResourceID-r16 of the positioning reference signal and/or the repetition index value of the PRS resource. The receiver completes synchronization with the transmitter through the transmission time corresponding to the received positioning reference signal ID. More specifically, for example, the receiver may use the transmission time corresponding to the identity ID of the reference signal for positioning as the transmission time of the reference signal for positioning, and use a difference value between a local reception time of the reference signal for positioning and the transmission time as transmission time of the reference signal for positioning; and the receiver infers the transmission time of the reference signal for positioning of the receiver according to the reception time and the transmission time of the reference signal for positioning, to complete synchronization with the transmitter. Those skilled in the art should understand that, although the above-described IDs related to the PRS are described above as examples, yet the method for implementing synchronization of the clocks of the receiver and the transmitter according to the clock synchronization timestamp including the transmission time and the identity ID of the reference signal for positioning (e.g., the SRS-POS) associated therewith is also considered within the scope of the present disclosure.
The receiver may be a UE or a base station or an LMF or a sidelink device (e.g., a device supporting a sidelink); and the transmitter may be a UE or a base station or an LMF or a sidelink device (e.g., a device supporting a sidelink).
In some embodiments, the first condition may be that positioning accuracy is less than a fifth threshold value and/or the RSRP of the reference signal for positioning received by the receiver is less than a sixth threshold value. The fifth threshold value and the sixth threshold value may be parameter values subject to user equipment UE capability, and/or parameter values configured by the base station (e.g., parameter values configured by the base station that are received by the UE), and/or preconfigured parameter values.

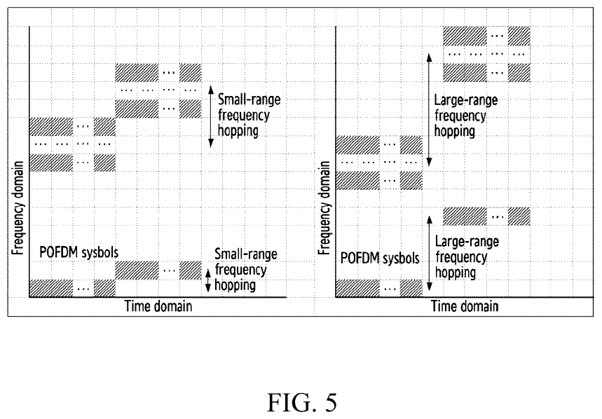

Based on any one of the above-described embodiments, when the carrier phase-based positioning measurement method is used to perform positioning measurement, a residual carrier phase shift may also be compensated for, so as to improve positioning accuracy. The method for compensating for residual carrier phase shift may include a combination of one or more of items below:
When performing carrier phase-based positioning measurement through a single carrier and/or multiple carriers, the transmitter transmits the reference signal for positioning using P consecutive OFDM symbols in the time domain, to compensate for residual carrier phase shift of the carrier phase-based positioning measurement method; correspondingly, the receiver receives the reference signal for positioning through P consecutive OFDM symbols; or the transmitter transmits the reference signal for positioning using an OFDM symbol group, wherein, the OFDM symbol group includes the OFDM symbols consecutive in the time domain, to compensate for residual carrier phase shift of the carrier phase-based positioning measurement method, correspondingly, the receiver receives the reference signal for positioning through the OFDM symbol group; and/or the receiver separates residual carrier phase shift from carrier phase shift after frequency hopping by means of frequency hopping to compensate for residual carrier phase shift of the carrier phase-based positioning measurement method, wherein, P may be an integer greater than or equal to 1. The means of frequency hopping are divided into small-range frequency hopping and/or large-range frequency hopping, wherein, a range of small-range frequency hopping may be fixed to RI frequency domain units or a value specified by the base station or the LMF, and a range of large-range frequency hopping may be fixed to R2 frequency domain units or a value specified by the base station or the LMF. For example, as shown in FIG. 5.)
When carrier phase-based positioning measurement is performed through a single carrier and/or multiple carriers, the transmitter transmits a reference signal for positioning F times for carrier phase-based positioning measurement. Optionally, when a transmission time gap of the reference signal is in a range of less than a seventh threshold value, and/or when the positioning measurement accuracy requirement is satisfied, the transmitter transmits the reference signal for positioning F times for carrier phase-based positioning measurement. Wherein, F is an integer greater than or equal to 1. By using the reference signal time difference and/or the carrier phase of q times of measurements of the reference signal for positioning, the receiver may reduce residual carrier phase shift (by statistical means, e.g., calculating an average value, a maximum value, etc.). The range of the seventh threshold value is for a coherence time of the reference signal for positioning or a coherence bandwidth of the reference signal for positioning. The q may be a parameter value subject to user equipment UE capability, and/or a parameter value configured by the base station (e.g., a parameter value configured by the base station that is received by the UE), and/or a preconfigured parameter value. The q may be an integer greater than or equal to 1.
The seventh threshold value may be a parameter value subject to user equipment UE capability, and/or a parameter value configured by the base station (e.g., a parameter value configured by the base station that is received by the UE), and/or a preconfigured parameter value.

Based on any one of the above-described embodiments, measurement results reported and/or transmitted when the carrier phase-based positioning measurement method is used for positioning measurement may include at least one of items below:
Carrier phase measurement result. When the carrier phase-based positioning measurement method is used for positioning measurement, excessively low received signal strength and/or multipaths of the reference signal and/or changes in moving scatterers in environment may lead to a phase jumping phenomenon. Considering the occasional phase jumping phenomenon during the positioning process, the reported carrier phase measurement result may include an integer part carrier phase difference and/or a fractional part carrier phase difference between the receiver and the transmitter, and/or an integer part carrier phase difference and/or a fractional part carrier phase difference between a current carrier phase measurement and a last carrier phase measurement. For example, only the fractional part carrier phase difference between the current carrier phase measurement and the last carrier phase measurement needs to be measured and/or calculated, without re-measuring and/or calculating the integer part carrier phase difference between the receiver and the transmitter; in this way, the positioning measurement result of the current carrier phase may be updated based on the carrier phase measured last time and the fractional part carrier phase difference. Optionally, the above-described method is applicable to cases where no phase jumping is detected and/or the RSRP value of the received reference signal for positioning is greater than or equal to/not less than an eighth threshold value and/or positioning accuracy is greater than or equal to/not less than a ninth threshold value; or, the receiver needs to re-measure and/or calculate the integer part carrier phase difference and the fractional part carrier phase difference between the receiver and the transmitter, without being influenced by the carrier phase measurement result of last measurement. Optionally, the above-described method is applicable to cases where phase jumping is detected and/or the RSRP value of the received reference signal for positioning is less than the eighth threshold value and/or positioning accuracy is less than the ninth threshold value.
Reference Signal Time Difference (RSTD). When the carrier phase-based positioning measurement method is used alone for positioning measurement, the receiver calculates the RSTD between the receiver and the transmitter according to the measured carrier phase difference, and directly reports the RSTD measurement result. When the carrier phase-based positioning measurement method and other positioning measurement methods are used in combination for positioning measurement, for example, when the carrier phase-based positioning measurement method and the TDOA measurement method are used at the same time for positioning measurement, the carrier phase-based positioning measurement result may be used to correct the RSTD obtained by using a result of the TDOA measurement method, and then the corrected RSTD measurement result is reported. Optionally, when the carrier phase-based positioning measurement method is used for uplink positioning measurement, the calculation method of reference signal time difference may include a combination of one or more of items below:
If positioning measurement (e.g., uplink positioning measurement) is performed using the reference signal for positioning (e.g., the SRS-POS) transmitted by using a timing advance method, a calculation formula of the reference signal time difference is RSTD=(TA+δ(t))/2. Wherein, TA represents timing advance time, and δ(t) is a clock offset error between the receiver and the transmitter.
If positioning measurement (c.g., uplink positioning measurement) is performed using the reference signal for positioning (e.g., the SRS-POS) transmitted not by using the timing advance method, the calculation formula of the reference signal time difference is RSTD=δ(t)/2. Where, δ(t) is the clock offset error between the transmitter and the receiver.
The receiver may be a UE or a base station or an LMF or a sidelink device (e.g., a device supporting a sidelink); and the transmitter may be a UE or a base station or an LMF or a sidelink device (e.g., a device supporting a sidelink).
The eighth threshold value and/or the ninth threshold value may be a parameter value subject to user equipment UE capability, and/or a parameter value configured by the base station (e.g., a parameter value configured by the base station that is received by the UE), and/or a preconfigured parameter value.

When the carrier phase-based positioning measurement method is used for uplink positioning measurement, the error of positioning measurement will be reduced, so that the clock offset error δ(t) used to calculate the reference signal time difference is more accurate. Therefore, accuracy of the reference signal time difference may be improved, to further improve accuracy of the positioning measurement result.

FIG. 5 illustrates an example of small-range frequency hopping and large-range frequency hopping as well as consecutive OFDM symbols and/or a symbol group used to transmit a reference signal for positioning that may be used to compensate for a residual carrier phase shift of a carrier phase-based positioning measurement method when carrier phase-based positioning measurement is performed through a single carrier and/or multiple carriers.

In FIG. 5, when carrier phase-based positioning measurement is performed through a single carrier and/or multiple carriers, in order to reduce residual carrier phase shift of the carrier phase-based positioning measurement method, the reference signal for positioning may be transmitted by means of small-range frequency hopping and large-range frequency hopping, and transmitting a symbol group of the reference signal for positioning. Those skilled in the art should understand that the small-range frequency hopping and large-range frequency hopping shown in FIG. 5 are only examples, and other ranges of small-range frequency hopping and large-range frequency hopping may also be used without departing from the concept of the present disclosure.

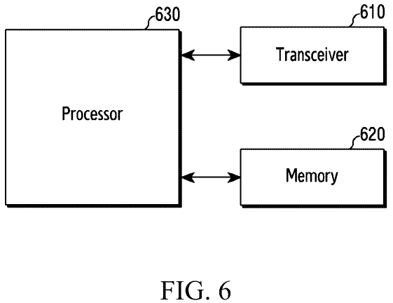

FIG. 6 illustrates a block diagram of a terminal (or a user equipment (UE)), according to embodiments of the present disclosure. FIG. 6 corresponds to the example of the UE of FIG. 3A.

As shown in FIG. 6, the UE according to an embodiment may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

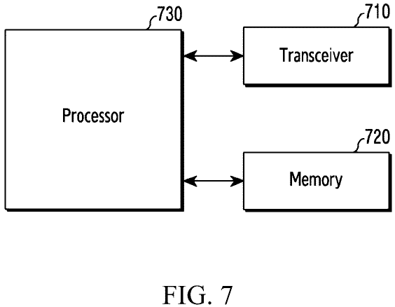

FIG. 7 illustrates a block diagram of a base station, according to embodiments of the present disclosure. FIG. 7 corresponds to the example of the gNB of FIG. 3B.

As shown in FIG. 7, the base station according to an embodiment may include a transceiver 710, a memory 720, and a processor 730. The transceiver 710, the memory 720, and the processor 730 of the base station may operate according to a communication method of the base station described above. However, the components of the base station are not limited thereto. For example, the base station may include more or fewer components than those described above. In addition, the processor 730, the transceiver 710, and the memory 720 may be implemented as a single chip. Also, the processor 730 may include at least one processor.

The transceiver 710 collectively refers to a base station receiver and a base station transmitter, and may transmit/receive a signal to/from a terminal or a network entity. The signal transmitted or received to or from the terminal or a network entity may include control information and data. The transceiver 710 may include a RF transmitter for up-converting and amplifying a frequency of a transmitted signal, and a RF receiver for amplifying low-noise and down-converting a frequency of a received signal. However, this is only an example of the transceiver 710 and components of the transceiver 710 are not limited to the RF transmitter and the RF receiver.

Also, the transceiver 710 may receive and output, to the processor 730, a signal through a wireless channel, and transmit a signal output from the processor 730 through the wireless channel.

The memory 720 may store a program and data required for operations of the base station. Also, the memory 720 may store control information or data included in a signal obtained by the base station. The memory 720 may be a storage medium, such as read-only memory (ROM), random access memory (RAM), a hard disk, a CD-ROM, and a DVD, or a combination of storage media.

The processor 730 may control a series of processes such that the base station operates as described above. For example, the transceiver 710 may receive a data signal including a control signal transmitted by the terminal, and the processor 730 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

“User equipment” or “UE” herein may refer to any terminal having wireless communication capabilities, including but not limited to a mobile phone, a cellular phone, a smart phone or a Personal Digital Assistant (PDA), a portable computer, an image capture device such as a digital camera, a gaming device, a music storage and playback device, and any portable unit or terminal having wireless communication capabilities, or an Internet facility that allows wireless Internet access and browsing, etc.

The term “base station” (BS) or “network device” as used herein may refer to an eNB, an eNodeB, a NodeB or a base station transceiver (BTS) or a gNB, etc., depending on the technology and terminology used.

“Memory” herein may be of any type suitable for the technical environment herein and may be implemented by using any suitable data memory technology, including but not limited to a semiconductor-based memory device, a magnetic memory device and system, an optical memory device and system, a fixed memory and a removable memory.

The processor herein may be of any type suitable for the technical environment herein, including but not limited to one or more of items below: a general purpose computer, a special purpose computer, a microprocessor, a Digital Signal Processor (DSP), and a processor based on a multi-core processor architecture.

The above merely are preferred embodiments of the present disclosure and are not intended to limit the present disclosure. Any modification, equivalent substitution, improvement, and the like, made within the spirit and principles of the present disclosure should be covered within the protection scope of the present disclosure.

Those skilled in the art may understand that the present disclosure includes devices for performing one or more of the operations described in the present disclosure. These devices may be specially designed and fabricated for required purposes or may also include those known devices in general purpose computers. These devices have computer programs stored therein; and these computer programs are selectively activated or reconfigured. Such a computer program may be stored in a device (e.g., a computer) readable medium or stored in any type of medium suitable for storing electronic instructions and respectively coupled to a bus; the computer readable medium includes, but is not limited to, any type of disk (including a floppy disk, a hard disk, an optical disk, a CD-ROM, and a magneto-optical disk), a Read-Only Memory (ROM), a Random Access Memory (RAM), an Erasable Programmable Read-Only Memory (EPROM), an Electrically Erasable Programmable Read-Only Memory (EEPROM), a flash memory, a magnetic card or an optical card. That is, a readable medium includes any medium that stores or transmits information in a form that may be read by a device (e.g., a computer).

Those skilled in the art may understand that computer program instructions may be used to implement each block of these structural diagrams and/or block diagrams and/or flow diagrams, and combinations of blocks in these structural diagrams and/or block diagrams and/or flow diagrams. Those skilled in the art may understand that, these computer program instructions may be provided to a general-purpose computer, a professional computer or a processor of other programmable data processing methods to implement, so that solutions specified in a block or a plurality of blocks of the structural diagrams and/or block diagrams and/or flow diagrams disclosed by the present disclosure may be executed by a computer or a processor of other programmable data processing method.

Those skilled in the art may recognize that, the present disclosure may be implemented in other specific forms without changing the technical idea or essential features of the present disclosure. Therefore, it should be understood that the above-described embodiments are merely examples and are not limited. The scope of the present disclosure is defined by the appended claims, rather than detailed description. Therefore, it should be understood that all modifications or changes derived from the meaning and scope of the appended claims and equivalents thereof are within the scope of the present disclosure.

In the above-described embodiments of the present disclosure, all operations and steps may be selectively performed or may be omitted. Furthermore, operations and steps in each embodiment need not be performed sequentially, and the order of operations and steps may vary.

Although the present disclosure has been illustrated and described with reference to various embodiments of the present disclosure, those skilled in the art will understand that various changes may be made in form and detail without departing from the spirit and scope of the present disclosure as defined by the appended claims and equivalents thereof.

1.-15. (canceled)

16. A method performed by a user equipment (UE) in a wireless communication system, the method comprising:
receiving, from a base station (BS), configuration information of on a downlink (DL) positioning reference signal (DL PRS), wherein the configuration information includes information on a DL reference signal carrier phase difference (DL RSCPD);
performing a measurement of the DL PRS based on the configuration information; and
transmitting, to the BS, a result of the measurement including the DL RSCPD based on the configuration information.

17. The method of claim 16,
wherein the result of the measurement further includes a DL reference signal time difference (DL RSTD).

18. The method of claim 16,
wherein the DL RSCPD indicates a difference of DL reference signal carrier phases (DL RSCPs), and
wherein a DL RSCP indicates a phase associated with a first path on which a DL PRS is received.

19. The method of claim 16,
wherein the configuration information includes a line of sight (LoS) or a non-line of sight (NLoS) indicator for carrier phase-based positioning measurement, and wherein the LoS or the NLOS indicator is applied to the measurement of the DL PRS.

20. The method of claim 16,
wherein the result of the measurement includes a timestamp associated with a DL reference signal carrier phase (DL RSCP) or the DL RSCPD, and
wherein the timestamp includes a symbol index.

21. A method performed by a base station (BS) in a wireless communication system, the method comprising:
transmitting, to a user equipment (UE), configuration information on a downlink (DL) positioning reference signal (DL PRS), wherein the configuration information includes information on a DL reference signal carrier phase difference (DL RSCPD);
transmitting, to the UE, the DL PRS; and
receiving, from the UE, a result of a measurement of the DL PRS, wherein the result of the measurement includes the DL RSCPD based on the configuration information.

22. The method of claim 21,
wherein the result of the measurement further includes a DL reference signal time difference (DL RSTD).

23. The method of claim 21,
wherein the DL RSCPD indicates a difference of DL reference signal carrier phases (DL RSCPs), and
wherein a DL RSCP indicates a phase associated with a first path on which a DL PRS is transmitted.

24. The method of claim 21,
wherein the configuration information includes a line of sight (LoS) or a non-line of sight (NLoS) indicator for carrier phase-based positioning measurement, and
wherein the LoS or the NLOS indicator is associated with the measurement of the DL PRS.

25. The method of claim 21,
wherein the result of the measurement includes a timestamp associated with a DL reference signal carrier phase (DL RSCP) or the DL RSCPD, and
wherein the timestamp includes a symbol index.

26. A user equipment (UE) in a wireless communication system, the UE comprising:
a transceiver; and
a controller coupled with the transceiver and configured to:
receive, from a base station (BS), configuration information on a downlink (DL) positioning reference signal (DL PRS), wherein the configuration information includes information on a DL reference signal carrier phase difference (DL RSCPD);
perform a measurement of the DL PRS based on the configuration information; and
transmit, to the BS, a result of the measurement including the DL RSCPD based on the configuration information.

27. The UE of claim 26,
wherein the result of the measurement further includes a DL reference signal time difference (DL RSTD).

28. The UE of claim 26,
wherein the DL RSCPD indicates a difference of DL reference signal carrier phases (DL RSCPs), and
wherein a DL RSCP indicates a phase associated with a first path on which a DL PRS is received.

29. The UE of claim 26,
wherein the configuration information includes a line of sight (LoS) or a non-line of sight (NLoS) indicator for carrier phase-based positioning measurement, and
wherein the LoS or the NLOS indicator is applied to the measurement of the DL PRS.

30. The UE of claim 26,
wherein the result of the measurement includes a timestamp associated with a DL reference signal carrier phase (DL RSCP) or the DL RSCPD, and
wherein the timestamp includes a symbol index.

31. A base station (BS) in a wireless communication system, the base station comprising:
a transceiver; and
a controller coupled with the transceiver and configured to:
transmit, to a user equipment (UE), configuration information on a downlink (DL) positioning reference signal (DL PRS), wherein the configuration information includes information on a DL reference signal carrier phase difference (DL RSCPD);
transmit, to the UE, the DL PRS; and
receive, from the UE, a result of a measurement of the DL PRS, wherein the result of the measurement includes the DL RSCPD based on the configuration information.

32. The BS of claim 31,
wherein the result of the measurement further includes a DL reference signal time difference (DL RSTD).

33. The BS of claim 31,
wherein the DL RSCPD indicates a difference of DL reference signal carrier phases (DL RSCPs), and
wherein a DL RSCP indicates a phase associated with a first path on which a DL PRS is transmitted.

34. The BS of claim 31,
wherein the configuration information includes a line of sight (LoS) or a non-line of sight (NLoS) indicator for carrier phase-based positioning measurement, and
wherein the LoS or the NLOS indicator is associated with the measurement of the DL PRS.

35. The BS of claim 31,
wherein the result of the measurement includes a timestamp associated with a DL reference signal carrier phase (DL RSCP) or the DL RSCPD, and
wherein the timestamp includes a symbol index.
